(19) United States
(12) Patent Application Publication
(10) Pub. No.: US 2008/0018554 A1
(43) Pub. Date: Jan. 24, 2008

(54) DISPLAY SYSTEM AND DISPLAY CONTROL METHOD

(75) Inventor: Masayuki Odagawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/775,669

(22) Filed: Jul. 10, 2007

(30) Foreign Application Priority Data
Jul. 18, 2006 (JP) 2006-196242

(51) Int. Cl. G09G 5/00

(52) U.S. Cl. 345/5; 345/1.1

(57) ABSTRACT

A display system has a single screen configured of plural display devices, and the system comprises: a receiving unit adapted to receive plural pieces of image data; a segmentation unit adapted to segment the received plural pieces of image data in accordance with the arrangement of the plural display devices; a distribution unit adapted to distribute each piece of segmented image data to a display device corresponding thereto; and a process allocation unit adapted to allocate, to each display device, process details to be executed, wherein the process allocation unit changes the process details allocated to each display device based on the amount of time required for the process executed by each display device and/or the amount of data of the process executed by each display device; and the distribution unit distributes each piece of segmented image data in accordance with the changed allocated process details.

### BACKGROUND OF THE INVENTION

1. Field of the Invention

The present invention relates to a display system and a display control method executed by the display system that composes a single large screen using a plurality of display devices, and in particular to distribution processing in the plurality of display devices when displaying plural pieces of image data simultaneously.

2. Description of the Related Art

A conventional display system that composes a single screen using a plurality of display devices is known.

The display system of Japanese Patent Laid-Open No. 7-64529, a configuration of which is shown in FIG. 6, can be given as an example of this type of display system. In FIG. 6, 1001 is an image scaling device (image scaling circuit), and 1010-1021 are display devices. The image scaling device 1001 performs scaling processing on received image data that scales the received image data to the size of a single screen configured of the plural display devices 1010-1021. Then, the image scaling device 1001 segments the scaled image data according to the arrangement positions of the plural display devices 1010-1021, and provides the segmented image data to the respective corresponding display devices.

In addition, a conventional display system that simultaneously displays plural pieces of image data is known. The display system of Japanese Patent Laid-Open No. 10-84517, a configuration of which is shown in FIG. 7, can be given as an example of this type of display system.

The display system shown in FIG. 7 comprises signal input circuits 1101-1103, image circuits 1111-1113, an image synthesis circuit 1120, and an image display circuit 1130.

The image circuits 1111-1113 perform a predetermined processing on image data inputted from the signal input circuits 1101-1103 respectively.

The image synthesis circuit 1120 synthesizes the respective image data processed by the image circuits 1111-1113 and outputs the resultant to the image display circuit 1130; the image display circuit 1130 then displays the synthesized image data.

However, in the configuration of the above-mentioned conventional display systems, in the case of displaying plural pieces of image data simultaneously, the amount of image data handled by each display device differs in that one display device displays only a single image whereas another display device displays a plurality of images.

For this reason, imbalances arise in the amount of image data transmitted over each wire connecting the display devices to one another. There is a further problem in that the processing burdens placed on a display device that handles a small amount of image data and a display device that handles a large amount of image data are different. As a result, there are cases where plural pieces of image data cannot be displayed in real time without lag in a single screen configured of a plurality of display devices.

### SUMMARY OF THE INVENTION

Having been conceived in light of the foregoing problem with the conventional art, it is an object of the present invention to provide a display system and a display control method executed by a display system that can display plural pieces of image data in real time without lag in a single screen configured of a plurality of display devices.

According to one aspect of the present invention, a display system having a single screen configured of plural display devices, the system comprises:

a receiving unit adapted to receive plural pieces of image data;

a segmentation unit adapted to segment the received plural pieces of image data in accordance with the arrangement of the plural display devices;

a distribution unit adapted to distribute each piece of segmented image data to a display device corresponding thereto; and

a process allocation unit adapted to allocate, to each display device, process details to be executed,

wherein the process allocation unit changes the process details allocated to each display device based on the amount of time required for the process executed by each display device and/or the amount of data of the process executed by each display device; and

the distribution unit distributes each piece of segmented image data in accordance with the changed allocated process details.

According to another aspect of the present invention, a display control method executed by a display system in which a single screen is configured of plural display devices, the method comprises:

a receiving step of receiving plural pieces of image data;

a segmentation step of segmenting the received plural pieces of image data in accordance with the arrangement of the plural display devices;

a distribution step of distributing each piece of segmented image data to a corresponding display device; and

a process allocation step of allocating, to each display device, process details to be executed,

wherein the process allocation step changes the process details allocated to each display device based on the amount of time required for the process executed by each display device and/or the amount of data of the process executed by each display device; and

the distribution step distributes each piece of segmented image data in accordance with the changed allocated process details.

Further features of the present invention will become apparent from the following description of exemplary embodiments (with reference to the attached drawings).

### BRIEF DESCRIPTION OF THE DRAWINGS

FIG. 1 is a block diagram showing a display system according to an embodiment of the present invention.

FIG. 2 is a diagram showing a state in which plural pieces of image data are superimposed and displayed.

FIG. 3A is a diagram showing DVD image data in a scaled state.

FIG. 3B is a diagram showing LAN image data in a scaled state.

FIG. 4A is a diagram showing a segmented state of scaled DVD image data.

FIG. 4B is a diagram showing a segmented state of scaled LAN image data.

FIG. 5 is a diagram showing process distribution in a display device.

FIG. 6 is a block diagram showing a conventional display system.

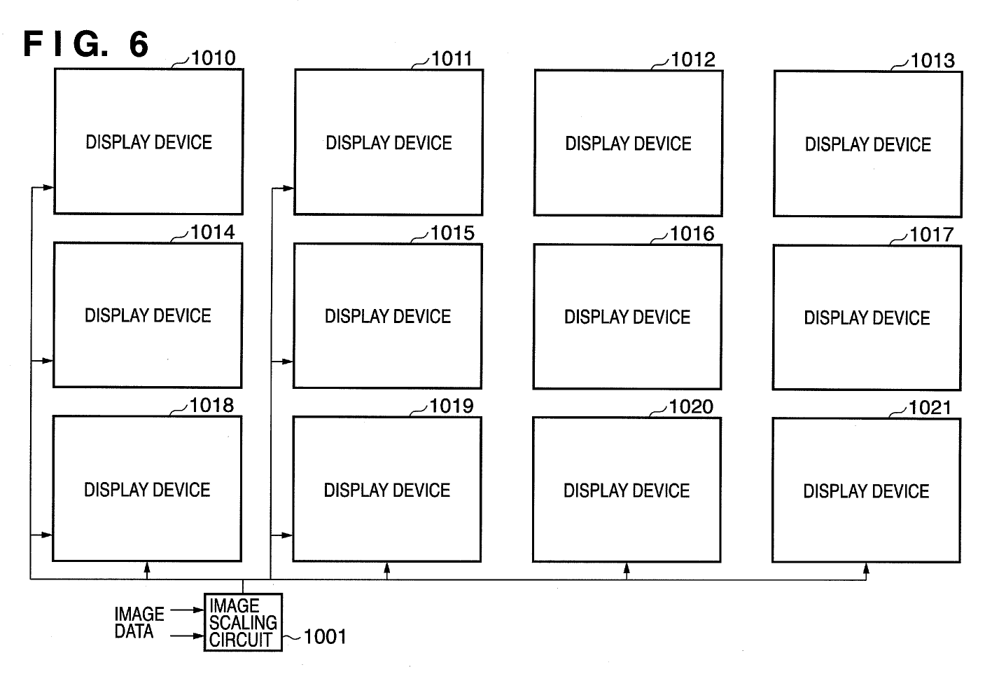

FIG. 7 is a block diagram showing a conventional display device.

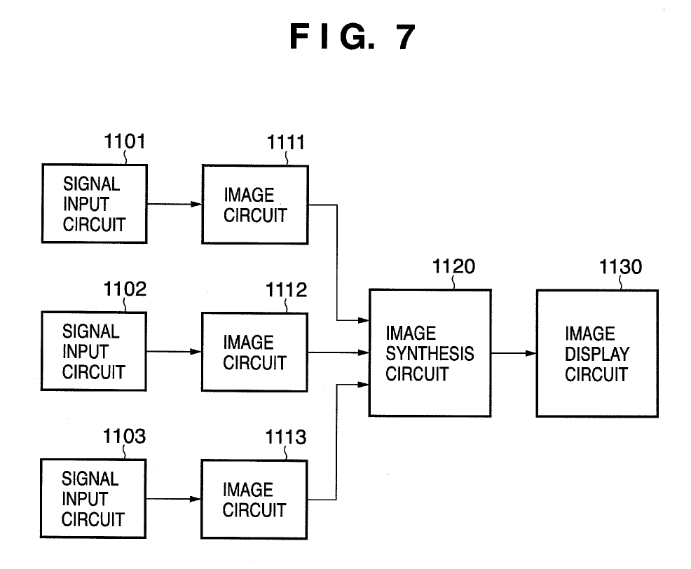

### DESCRIPTION OF THE EMBODIMENTS

Hereinafter, an embodiment of the present invention shall be described with reference to the Drawings.

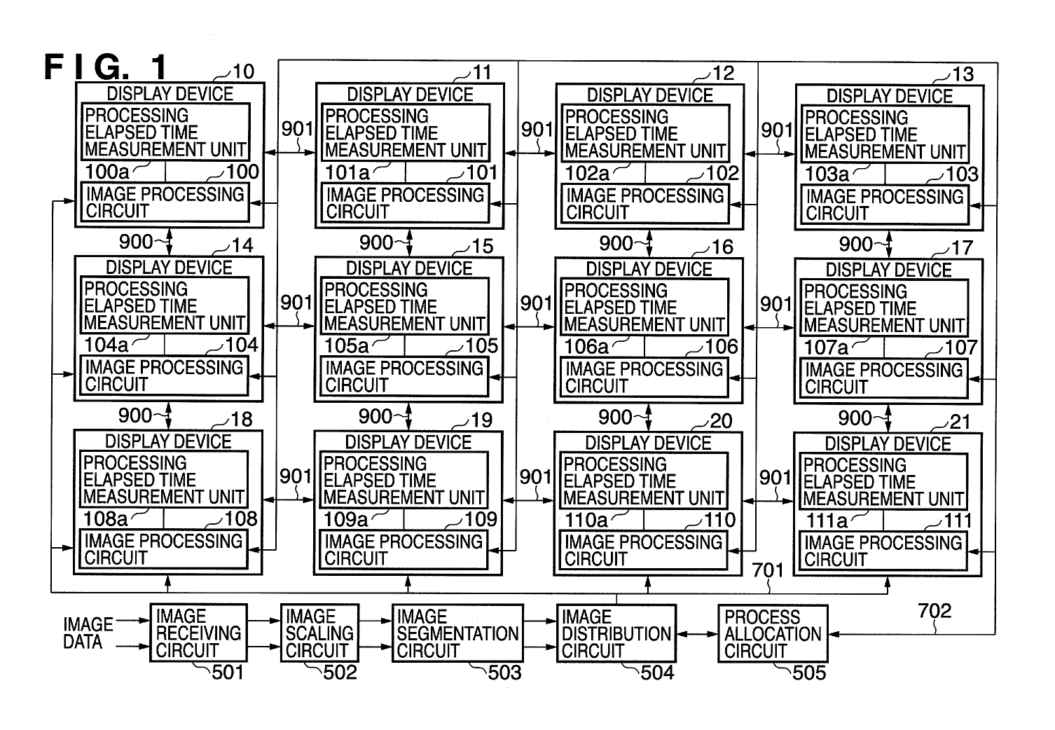

FIG. 1 is a block diagram showing a display system according to an embodiment of the present invention.

The display system according to an embodiment of the present invention includes display devices 10-21, an image receiving circuit 501, an image scaling circuit 502, an image segmentation circuit 503, an image distribution circuit 504, and a process allocation circuit 504. The display devices 10-21 respectively include image processing circuits 100-111.

The display devices 10-21 are arranged in a 4 (horizontal)×3 (vertical) grid pattern as shown in FIG. 1, thereby forming a single large screen. Moreover, each display device is capable of receiving plural pieces of image data; each display device performs image enhancement processing, synthesis processing, and the like on the received plural pieces of image data, and displays the processed image data on a display screen.

The image processing circuits 100-111 perform image enhancement processing, synthesis processing, and the like on the image data received by the respective display devices 10-21. The processing to be performed by the image processing circuits 100-111 is determined by the process allocation circuit 505 and is notified to the image processing circuits 100-111 via an image processing notification line 702.

The image receiving circuit 501 is capable of receiving image data distributed through television broadcast and Internet broadcast, from an image server, or the like, and is capable of receiving image data from a plurality of image sources simultaneously.

The image scaling circuit 502 performs scaling processing on the image data received by the image receiving circuit 501 in accordance with a predetermined screen size. The “predetermined screen size” includes the size of a single screen composed of the display devices 10-21 or the size of a screen composed of a number of the display devices, and can be switched in accordance with the type of image data received by the image receiving circuit 501.

The image segmentation circuit 503 performs segmentation processing on the image data scaled by the image scaling circuit 502 in accordance with the arrangement of the display devices 11-21.

The image distribution circuit 504 distributes the image data segmented by the image segmentation circuit 503 to corresponding display devices in accordance with the result of process allocation performed by the process allocation circuit 505.

The process allocation circuit 505 determines how to allocate processing of the image data to each display device in accordance with the arrangement of the display devices 10-21 and the screen size and the like of the received image data.

In FIG. 1, 701 is an image data distribution line for distributing the segmented image data to the respective display devices, and 702 is an image processing notification line for notifying the image processing circuits 100-111 of the processing to be performed on the segmented image data. Furthermore, 900 are vertical image data transmission lines through which the display devices 10-21 transfer image data to vertically adjacent display devices, whereas 901 are horizontal image data transmission lines through which the display devices 10-21 transfer image data to horizontally adjacent display devices.

Hereinafter, operations of the display system according to the embodiment of the present invention shall be described.

The image receiving circuit 501 receives plural pieces of image data. Here, image data is received on a frame-by-frame basis from two image sources, DVD and LAN. In the present embodiment, descriptions are provided in which the image sources comprise two channels, but the image sources may comprise n channels (n being an integer not less than 3) with no change to the operation of the display system of the present invention.

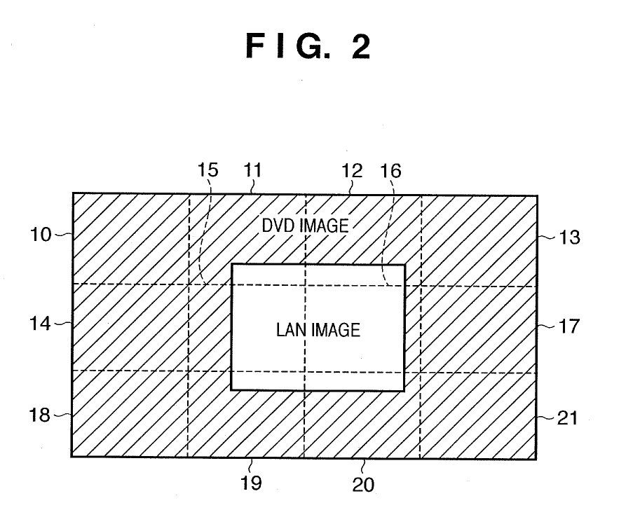

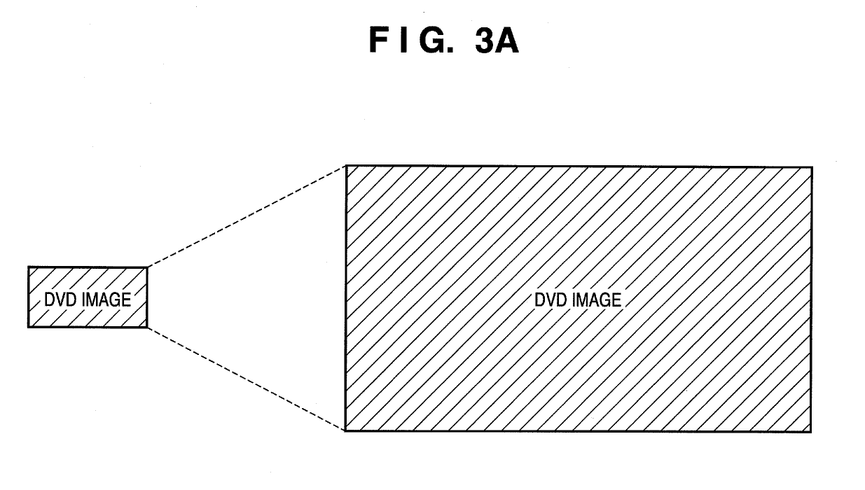

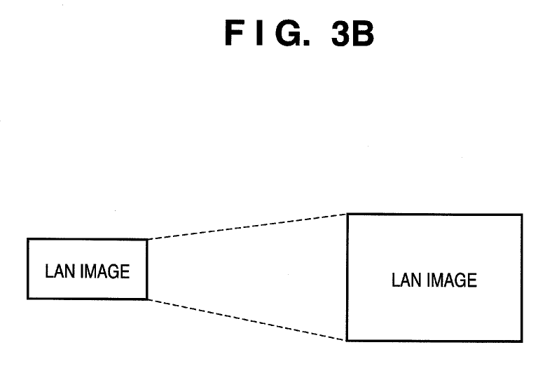

The image scaling circuit 502 performs scaling processing on the two pieces of image data received by the image receiving circuit 501. In the case of superimposing image data from the DVD and image data from the LAN and causing the resultant to be displayed, as shown in FIG. 2, the image data from the DVD and the image data from the LAN are scaled to a size at which they are to be displayed, as shown in FIGS. 3A and 3B respectively.

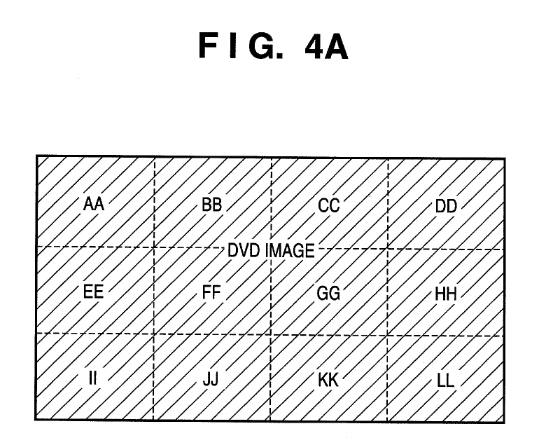

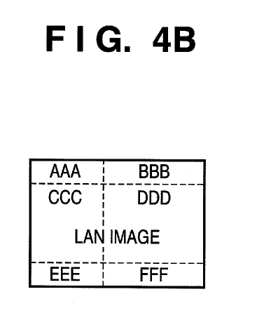

The image segmentation circuit 503 performs segmentation processing on the scaled image data. The image data is segmented in the manner shown in FIGS. 4A and 4B.

The parts included in the DVD image data are displayed in respective display devices as shown in FIG. 4A; in other words, part AA is displayed in the display device 10, part BB is displayed in the display device 11, part CC is displayed in the display device 12, part DD is displayed in the display device 13, part EE is displayed in the display device 14, part FF is displayed in the display device 15, and part GG is displayed in the display device 16. Furthermore, part HH is displayed in the display device 17, part II is displayed in the display device 18, part JJ is displayed in the display device 19, part KK is displayed in the display device 20, and part LL is displayed in the display device 21.

The parts included in the LAN image data are displayed in respective display devices as shown in FIG. 4B; in other words, part AAA is displayed in the display device 11, part BBB is displayed in the display device 12, part CCC is displayed in the display device 15, part DDD is displayed in the display device 16, part EEE is displayed in the display device 19, and part FFF is displayed in the display device 20.

The process allocation circuit 505 performs grouping on the display devices 10-21 and determines what processing is to be performed on each group. “Grouping” creates a group of plural display devices. The composition of the group is determined based on the arrangement of the display devices 10-21. In the present embodiment, the display devices are arranged in a 3 (vertical)×4 (horizontal) landscape grid. In this type of arrangement, a group is composed of a vertical row of display devices. For example, the display devices 10, 14, and 18 are group 1, the display devices 11, 15, and 19 are group 2, the display devices 12, 16, and 20 are group 3, and the display devices 13, 17, and 21 are group 4. Then, the process allocation circuit 505 determines that image processing is to be performed on parts AA, EE, and II of the DVD image data in the display devices included in group 1. The process allocation circuit 505 determines that image processing is to be performed on parts BB, FF, JJ, CC, GG, and KK of the DVD image data in the display devices included in group 2. The process allocation circuit 505 determines that synthesis processing is to be performed on parts AAA, CCC, and EEE of the LAN image data in the display devices included in group 2. In addition, the process allocation circuit 505 determines that image processing is to be performed on parts AAA, BBB, CCC, DDD, EEE, and FFF of the LAN image data in the display devices included in group 3. The process allocation circuit 505 determines that synthesis processing is to be performed on parts CC, GG, and KK of the DVD image data in the display devices included in group 3. The process allocation circuit 505 determines that image processing is to be performed on parts DD, HH, and LL of the DVD image data in the display devices included in group 4.

The process allocation circuit 505 furthermore determines which process to cause the image processing circuits included in the respective display devices within the group to perform.

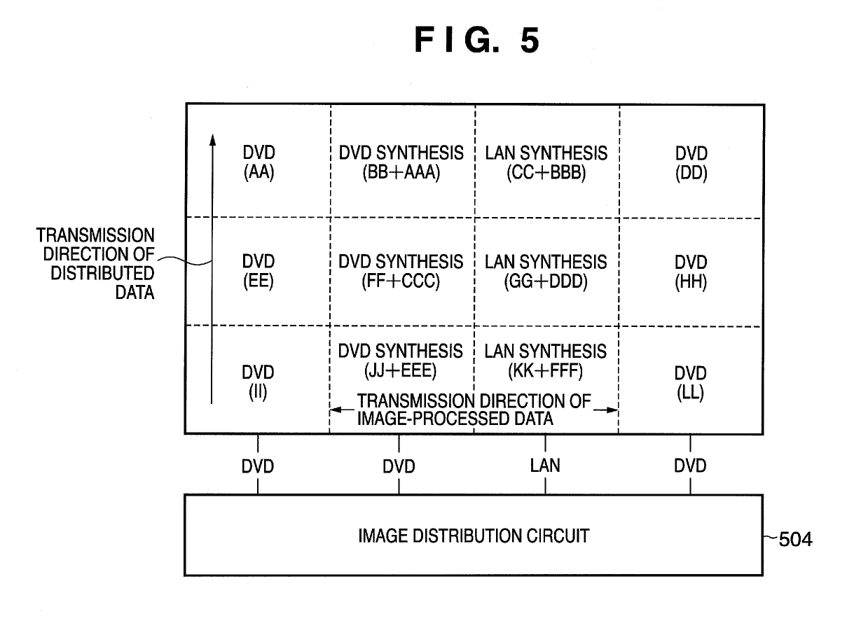

For example, the process allocation circuit 505 determines to cause the image processing circuits included in the respective display devices within group 1 to perform the following processes (processes (1)-(3)) (refer to FIG. 5).

(1) The image processing circuit 100 of the display device 10 is caused to perform image processing on part AA of the DVD image data. (2) The image processing circuit 104 of the display device 14 is caused to perform image processing on part EE of the DVD image data. (3) The image processing circuit 108 of the display device 18 is caused to perform image processing on part II of the DVD image data.

In addition, the process allocation circuit 505 determines to cause the image processing circuits included in the respective display devices within group 2 to perform the following processes ((4)-(6)) (refer to FIG. 5).

(4) The image processing circuit 101 of the display device 11 is caused to perform image processing on parts BB and CC of the DVD image data, and is further caused to synthesize the image-processed part BB of the DVD image data with the image-processed part AAA of the LAN image data. (5) The image processing circuit 105 of the display device 15 is caused to perform image processing on parts FF and GG of the DVD image data, and is further caused to synthesize the image-processed part FF of the DVD image data with the image-processed part CCC of the LAN image data. (6) The image processing circuit 109 of the display device 19 is caused to perform image processing on parts JJ and KK of the DVD image data, and is further caused to synthesize the image-processed part JJ of the DVD image data with the image-processed part EEE of the LAN image data.

In addition, the process allocation circuit 505 determines to cause the image processing circuits included in the respective display devices within group 3 to perform the following processes ((7)-(9)) (refer to FIG. 5).

(7) The image processing circuit 102 of the display device 12 is caused to perform image processing on parts AAA and BBB of the LAN image data, and is further caused to synthesize the image-processed part BBB of the LAN image data with the image-processed part CC of the DVD image data. (8) The image processing circuit 106 of the display device 16 is caused to perform image processing on parts CCC and DDD of the LAN image data, and is caused to synthesize the image-processed part DDD of the LAN image data with the image-processed part GG of the DVD image data. (9) The image processing circuit 110 of the display device 20 is caused to perform image processing on parts EEE and FFF of the LAN image data, and is further caused to synthesize the image-processed part FFF of the LAN image data with the image-processed part KK of the DVD image data.

For example, the process allocation circuit 505 determines to cause the image processing circuits included in the respective display devices within group 4 to perform the following processes (processes (10)-(12)) (refer to FIG. 5). (10) The image processing circuit 103 of the display device 13 is caused to perform image processing on part DD of the DVD image data. (11) The image processing circuit 107 of the display device 17 is caused to perform image processing on part HH of the DVD image data. (12) The image processing circuit 111 of the display device 21 is caused to perform image processing on part LL of the DVD image data.

Next, the image distribution circuit 504 distributes the corresponding image data to the respective display devices in accordance with the allocation determined by the process allocation circuit 505.

In accordance with the process details of each group allocated by the process allocation circuit 505, parts AA, EE, and II of the DVD image data are distributed from the image distribution circuit 504 to the display device 18. Parts BB, CC, FF, GG, JJ, and KK of the DVD image data are distributed from the image distribution circuit 504 to the display device 19. Parts AAA, BBB, CCC, DDD, EEE, and FFF of the LAN image data are distributed from the image distribution circuit 504 to the display device 20, and parts DD, HH, and LL of the DVD image data are distributed from the image distribution circuit 504 to the display device 21.

The display devices 18-21 each extract image data to be processed from the received image data, and transfer the remaining data to the adjacent display devices 14-17 via the image data transmission lines 900. For example, the display device 18 that has received parts AA, EE, and II of the DVD image data extracts part II, and transfers the remaining parts AA and EE of the DVD image data to the display device 14. In the same manner, the display devices 14-17 each extract image data to be processed, and transfer the remaining data to the adjacent display devices 10-13 via the image data transmission lines 900.

At this time, the process allocation circuit 505 notifies the display devices 10-21 of what process each display device is to perform via the image processing notification line 702.

The image processing circuits 100-111 included in the display devices 10-21 perform processes in accordance with the received image data and the process details. In group 1 and group 4, the display devices 10, 14, 18, 13, 17, and 21 respectively perform image processing on the DVD image data they received using the image processing circuits, and display the image-processed DVD image data.

In group 2, image processing is performed on the DVD image data by the image processing circuits of the display devices 11, 15, and 19, and the data among the image-processed DVD image data that is not to be displayed in the display devices 11, 15, and 19 is transferred to group 3 via the image data transmission lines 900. At the same time, in group 2, the display devices 11, 15, and 19 receive, from group 3, the image-processed LAN image data necessary for display, perform synthesis processing, and display a synthesized image. In group 3, image processing is performed on the LAN image data by the image processing circuits of the display devices 12, 16, and 20, and the data among the image-processed LAN image data that is not to be displayed in the display devices 12, 16, and 20 is transferred to group 2 via the image data transmission lines 901. At the same time, in group 3, the image-processed DVD image data necessary for display is received from group 2, synthesis processing is performed, and a synthesized image is displayed.

At this time, the processing elapsed time measurement units 100a-111a of the display devices 10-21 notify the process allocation circuit 505 of the time each display device requires for processing, using the image processing circuits 100-111 and via the image processing notification line 702.

The process allocation circuit 505 determines the grouping and process allocation for the data of the next frame based on the notified time required for processing.

For example, assuming the ratio of time required for image processing for one screen's worth of DVD image data, image processing for one screen's worth of LAN image data, and processing for synthesizing the DVD image data with the LAN image data is 2:2:1, the following is determined by the process allocation circuit 505.

The process allocation circuit 505 determines the display devices 10, 11, and 15 to be group 1. Then, the process allocation circuit 505 determines that image processing is to be performed by the image processing circuits 100 and 101 of the display devices 10 and 11 on parts AA, BB, and FF of the DVD image data. Furthermore, the process allocation circuit 505 determines that image processing and synthesis processing are to be performed by the image processing circuit 105 of the display device 15 on part AAA of the LAN image data.

The process allocation circuit 505 determines the display devices 14, 18, and 19 to be group 2. The process allocation circuit 505 determines that image processing is to be performed by the display devices 14 and 18 on parts EE, II, and JJ of the DVD image data. The process allocation circuit 505 determines that image processing and synthesis processing are to be performed by the display device 19 on part CCC of the LAN image data.

The process allocation circuit 505 determines the display devices 12, 13, and 16 to be group 3. The process allocation circuit 505 determines that image processing is to be performed by the display devices 12 and 13 on parts CC, DD, and GG of the DVD image data. The process allocation circuit 505 determines that image processing and synthesis processing are to be performed by the display device 16 on part BBB of the LAN image data.

The process allocation circuit 505 determines the display devices 17, 20, and 21 to be group 4. The process allocation circuit 505 determines that image processing is to be performed by the display devices 17 and 21 on parts HH, KK, and LL of the DVD image data. The process allocation circuit 505 determines that image processing and synthesis processing are to be performed by the display device 20 on part DDD of the LAN image data.

The image distribution circuit 504 distributes the image data segmented by the image segmentation circuit 503 to corresponding display devices in accordance with the result of grouping and process allocation determined by the process allocation circuit 505.

As has been described in detail thus far, according to the present embodiment, the process allocation circuit 505 determines the grouping and process allocation for the data of the next frame based on the time required for processing notified by each processing elapsed time measurement unit. Then, the image distribution circuit 504 distributes the image data segmented by the image segmentation circuit 503 to the corresponding display devices in accordance with the grouping and process allocation determined by the process allocation circuit 505. In this manner, by determining the next processing to be performed for a plurality of display devices in accordance with the time required for processing, the transmission lines connecting the display devices to one another, the transmission lines connecting each display device to the image distribution circuit, and the like can be used efficiently. Furthermore, plural pieces of image data can be transmitted in real time without lag.

While each display device includes a processing elapsed time measurement unit in the above embodiment, a data amount measurement unit that measures the amount of data processed by an image processing circuit may be included instead of the processing elapsed time measurement unit. In such a case, the amount of data measured by the data amount measurement unit is notified to the process allocation circuit 505. The process allocation circuit 505 determines the grouping and process allocation for the data of the next frame based on the notified data amount. The image distribution circuit 504 distributes the image data segmented by the image segmentation circuit 503 to corresponding display devices in accordance with the result of grouping and process allocation performed by the process allocation circuit 505. Thus the same effect as in the case of including the processing elapsed time measurement unit can be obtained.

In addition, while each display device includes a processing elapsed time measurement unit in the above embodiment, a single processing elapsed time measurement unit may be provided between the process allocation circuit 505 and the display devices. In such a case, the single processing elapsed time measurement unit measures the amount of time required for processing performed by each display device.

Furthermore, the object of the present invention can also be achieved by supplying, to a system or apparatus, a storage medium in which the program code for software that realizes the functions of the aforementioned embodiment has been stored, and causing a computer (or CPU, MPU, or the like) of the system or apparatus to read out and execute the program code stored in the storage medium.

In such a case, the program code read out from the storage medium realizes the functions of the aforementioned embodiment, and the program code and the storage medium in which the program code is recorded constitute the present invention.

Furthermore, a hard disk, magneto-optical disk, an optical disk such as a CD-ROM, CD-R, CD-RW, DVD-ROM, DVD-RAM, a non-volatile memory card, ROM, or the like can all be used as the storage medium for supplying the program code. Alternatively, the program code may be downloaded via a network.

Moreover, the present invention is not limited to the case where the functions of the aforementioned embodiment are realized by a computer executing the read-out program code. In other words, the case in which an operating system (OS) or the like run by the computer performs all or part of the actual processing based on instructions included in the program code, and the functions of the aforementioned embodiment are implemented through that processing, is also included within the scope of the present invention.

Furthermore, the case in which the program code read out from the storage medium is written into a memory included in an expansion board inserted into the computer, an expansion unit connected to the computer, or the like, a CPU or the like included in the expansion board or expansion unit then performs all or part of the actual processing based on instructions included in the program code, and the functions of the aforementioned embodiment are implemented through that processing, is also included within the scope of the present invention.

According to the present invention, the allocation of subsequent processing for a plurality of display devices is determined in accordance with the time required for processing, the data amount of the processing executed by each display device, or the like, as has been described thus far. Each piece of segmented image data is distributed to the corresponding display device in accordance with the determined allocation. Therefore, transmission of the image data is evenly distributed, and thus the transmission lines connecting the display devices to one another, the transmission lines connecting each display device to the image distribution circuit, and the like can be used efficiently. As a result, it is possible to display plural pieces of image data in real time without lag in a single screen configured of a plurality of display devices.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2006-196242, filed Jul. 18, 2006, which is hereby incorporated by reference herein in its entirety.

What is claimed is:

1. A display system having a single screen configured of plural display devices, the system comprising:
a receiving unit adapted to receive plural pieces of image data;
a segmentation unit adapted to segment the received plural pieces of image data in accordance with the arrangement of the plural display devices;
a distribution unit adapted to distribute each piece of segmented image data to a display device corresponding thereto; and
a process allocation unit adapted to allocate, to each display device, process details to be executed,
wherein the process allocation unit changes the process details allocated to each display device based on the amount of time required for the process executed by each display device and/or the amount of data of the process executed by each display device; and
the distribution unit distributes each piece of segmented image data in accordance with the changed allocated process details.

2. The display system according to claim 1,
wherein the process allocation unit performs grouping on the plural display devices.

3. The display system according to claim 2,
wherein the process allocation unit changes the grouping of the plural display devices based on the amount of time required for the process executed by each display device; and
the distribution unit distributes each piece of segmented image data to each display device included in a corresponding group, in accordance with the changed grouping of display devices.

4. The display system according to claim 1,
wherein each of the display devices includes a processing elapsed time measurement unit adapted to measure the amount of time required for the process executed by each display device.

5. A display control method executed by a display system in which a single screen is configured of plural display devices, the method comprising:
a receiving step of receiving plural pieces of image data;
a segmentation step of segmenting the received plural pieces of image data in accordance with the arrangement of the plural display devices;
a distribution step of distributing each piece of segmented image data to a corresponding display device; and
a process allocation step of allocating, to each display device, process details to be executed,
wherein the process allocation step changes the process details allocated to each display device based on the amount of time required for the process executed by each display device and/or the amount of data of the process executed by each display device; and
the distribution step distributes each piece of segmented image data in accordance with the changed allocated process details.
